(19) United States
(12) Patent Application Publication
(10) Pub. No.: US 2024/0235856 A1
(43) Pub. Date: Jul. 11, 2024

(54) PROOF OF POSSESSION ESTABLISHMENT DURING SECURE ONBOARDING

(71) Applicant: DELL PRODUCTS L.P., Round Rock, TX (US)

(72) Inventor: Bradley Keith Goodman, Nashua, NH (US)

(21) Appl. No.: 18/152,617

(22) Filed: Jan. 10, 2023

(51) Int. Cl. H04L 9/32; H04L 9/08; H04L 9/30

(52) U.S. Cl. CPC H04L 9/3271; H04L 9/0894; H04L 9/3073

(57) ABSTRACT

An endpoint node of a multiple node environment stores a public key of a public/private key pair, and a ownership voucher. A processor begins an onboarding process and receives a signed message that indicates safe possession of the endpoint node. The processor retrieves the public key from the ownership voucher in a storage of the endpoint node. Based on the public key, the processor determines whether the signed message is valid. In response to the signed message being valid, the processor unlocks the endpoint node.

### FIELD OF THE DISCLOSURE

The present disclosure generally relates to information handling systems, and more particularly relates to establishing proof of possession during secure onboarding.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An endpoint node of a multiple node environment includes a storage and a processor. The storage may store a public key of a public/private key pair, and an ownership voucher. The processor may begin an onboarding process and receive a signed message. The signed message indicates safe possession of the endpoint node. The processor may retrieve the public key from the ownership voucher in a storage of the endpoint node. Based on the public key, the processor may determine whether the signed message is valid. In response to the signed message being valid, the processor may unlock the endpoint node.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a multiple node environment according to at least one embodiment of the present disclosure;

FIG. 2 is a flow diagram of a method for unlocking an endpoint node in an anointed network according to at least one embodiment of the present disclosure;

FIG. 3 is a flow diagram of a method for providing an asynchronously signed message to activate or unlock an endpoint node according to at least one embodiment of the present disclosure;

FIG. 4 is a flow diagram of a method for providing and authenticating a local PKI challenge to activate or unlock an endpoint node according to at least one embodiment of the present disclosure; and

FIG. 5 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

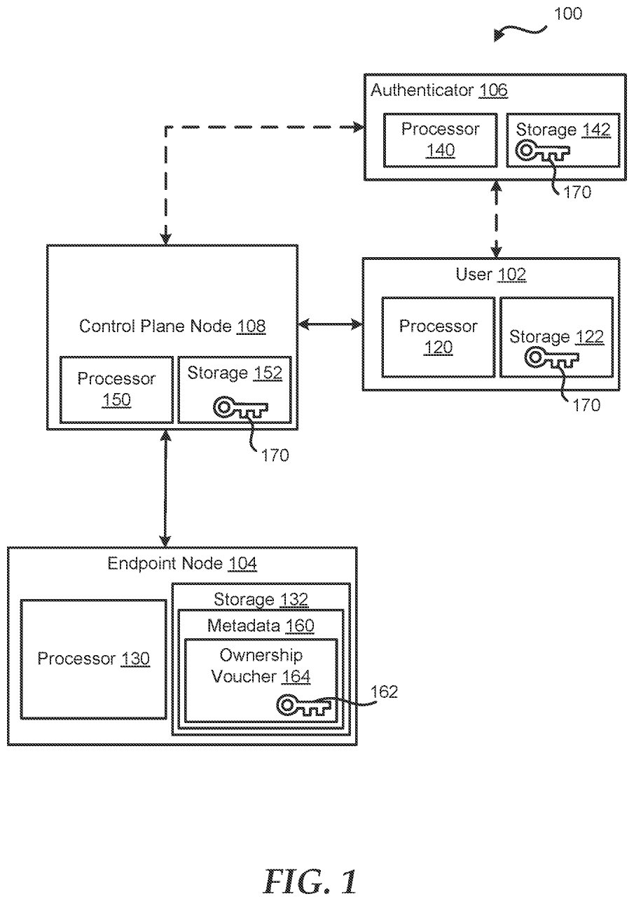

FIG. 1 illustrates a multiple node environment 100 according to at least one embodiment of the present disclosure. Multiple node environment 100 includes a user node 102, an endpoint node 104, an authenticator node 106, and a control plane node 108. In an example, user node 102 and authenticator node 106 may communicate with endpoint node 104 through control plane 108. In certain examples, user node 102 includes a processor 120 and a storage 122. Endpoint node 104 includes a processor 130 and a storage 132. Authenticator node 106 includes a processor 140 and a storage 142. Control plane node 108 includes a processor 150 and a storage 152.

In an example, endpoint node 104 may execute one or more services that a user may sign into via for user node 102. These services may include, but are not limited to, a web site and a remote system. In certain examples, authenticator 106 may be any suitable component or hardware device in possession of a user associated with user node 102. Authenticator 106 may hold or store a private key 160 associated with the user. In an example, authenticator 106 may be a platform component, such as a component within a laptop, a roaming authenticator which can be used on different devices, or the like. A roaming authenticator, such as a cellular telephone, a key fob, or the like, may be a FIDO2/WebAuthn key which is portable so that the roaming authenticator may be physically accessed by user node 102 via insertion, wireless pairing, NFC, or the like. FIDO2/WebAuthn is an industry-standard security system which uses public key infrastructure (PKI) to attest users.

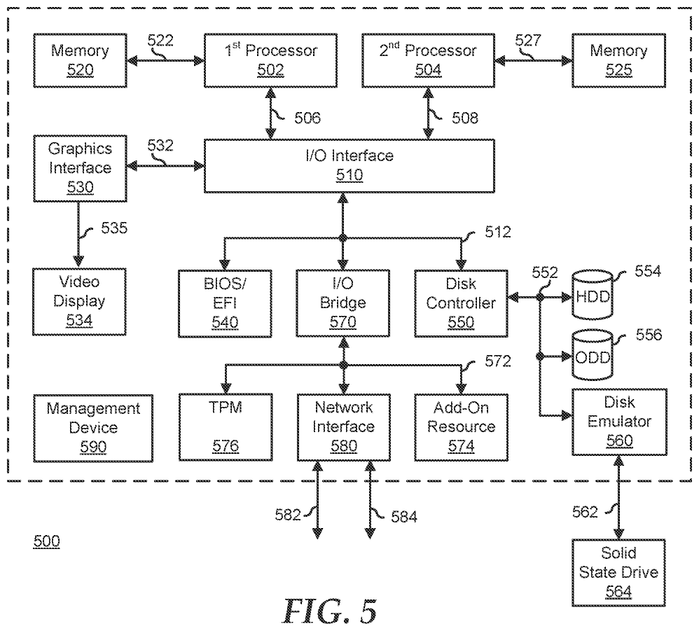

In certain examples, control plane 108 may include any suitable type of control-plane, such as a global control plane node, regional control plane node, and local control plane node. In an example, user node 102, endpoint node 104, and authenticator 106, and control plane node 108 may be any suitable information handling system, such as substantially similar to information handling system 500 of FIG. 5, wherein each node may include a storage and a processor as described below with respect to FIG. 5. Multiple node environment 100 may include any suitable number of additional components or information handling systems without varying from the scope of this disclosure.

In an example, endpoint node 104 may be a server or another information handling system that is shipped to a location and powered on for the first time. During the first power-on, endpoint node 104 one or more operations may be performed to provision and enroll the endpoint node. For example, endpoint node 104 may execute operations associated with zero touch provisioning (ZTP), secure onboarding (SO), secure zero touch provisioning (SZTP), or the like. In an example, ZTP may enable endpoint node 104 to be powered-on and automatically configured with no explicit action by a user. SO may enable endpoint node 104 to powered-on at a user's site, and automatically receive secrets, instructions, credentials and configuration data from that user in a provably secure and reliable manner. In an example, SZTP may integrate the operations of ZTP and SO together.

In previous information handling systems, the ZTP may present a potential security problem in that information handling system may be powered-on in insecure locations, by unauthorized people, and possibly by nefarious actors. In this situation, the information handling system may receive sensitive data, or work within sensitive operations under insecure or undesirable circumstances. Endpoint node 104 may be improved by the endpoint node requiring explicit authorization to operate by an authorized entity before the endpoint node is able to operate as will be described herein.

During an ordering process of endpoint node 104, a user may apply metadata 160 to the endpoint node. In certain examples, the user may be any suitable entity or person, such as a manufacturer, a reseller, or the like. In an example, metadata 160 may be received by endpoint node 104 via a late-binding process. Late binding of metadata 160 may involve the metadata not being stored in storage 132 of endpoint node 104 during manufacturing but rather by which a parallel voucher management process. In an example, the late binding may convey metadata information 160 to endpoint node 104 after manufacturing, and the endpoint node may need to onboard the metadata for any specific user or application. In this example, metadata 160 may be on boarded or loaded within storage 132 before endpoint node 104 is used by the end-user. For example, metadata 160 may be on boarded via secure onboarding at first power-on of endpoint node 104.

In an example, metadata 160 may include one or more public proof of possession (POP) encryption keys 162. PoP keys may be a public/private PKI key pair used to prove to endpoint node 104 that the rightful owner is in safe-possession or communication with the endpoint node. These keys 162 may be generated by a user, or an approved entity, and the user may hold private portion 170 of this key pair in storage 122 of user node 102. Public key 162 may be made available to the ordering system, so that it would be included inside an ownership voucher 164 in a section which was signed with private key 170. In certain examples, ownership voucher 164 may include metadata 160 and the ownership voucher may be signed, managed, and conveyed, independent of the physical machine itself. In an example, the signing of ownership voucher 164 may enable private key to be proven and recognized by user node 102, a reseller, or the like. Ownership voucher 164 may be a cryptographically signed document, which allows the manufacturer of endpoint node 104 to include data which can be proven to have originated from that manufacturer. Ownership voucher 164 may be conveyed to endpoint node 104 at first power-on via the SO process.

During the SZTP process of the first power-on of endpoint node 104, ownership voucher 164 may be received by the endpoint. At this point, endpoint node 104 may be powered on in one or multiple different circumstances. For example, endpoint node 104 may be in the possession of the correct owner within a secured site, the endpoint node may have been stolen during the delivery process and in the possession of a nefarious actor, or the like.

In certain example, SZTP may not be executed for any suitable reason including, but not limited to, if endpoint node 104 was disconnected from the public network, or unable to communicate with an appropriate onboarding service with the valid OV. In this situation, endpoint node 104 may effectively pause at this point, continuing to indefinitely attempt to find and connect to such an onboarding service. In an example, proof-of-possession public key 162 may be received in OV 164 via SZTP. Public key 162 may be utilized as a key that must be used to sign a message for endpoint node 104 to indicate that the endpoint node is connected with a proper entity.

In an example, a determination of whether endpoint node 104 is connected to a proper entity may or may not be proven by whether the endpoint node is able to communicate with control plane node 108. For example, if control plane is located in the public cloud, a nefarious actor would be able to reach the control plane, even in an undesired location. However, if control plane 108 is located within an anointed network, such as a private onsite network, communication between endpoint node 108 and the control plane may prove that the endpoint node is connected to a proper entity. In this situation, where control plane node 108 is in a local secure location, the control plane node 108 may receive private POP key 170 and store the private PoP key in storage 152. In an example, control plane node 108 may be able to unlock endpoint node 104 with private POP key 170. In an example, if a determination is made when endpoint node 104 is ordered that the endpoint node would be in an anointed network, a long-lived public key 162, such as a well-known POP key, may be permanently assigned or associated with control plane 108 located at that specific site or network. In this example, private POP key 162 may be conveyed for endpoint node 104 during the ordering process, and may be provided to the endpoint node by control plane node 108 during a late binding of the endpoint node.

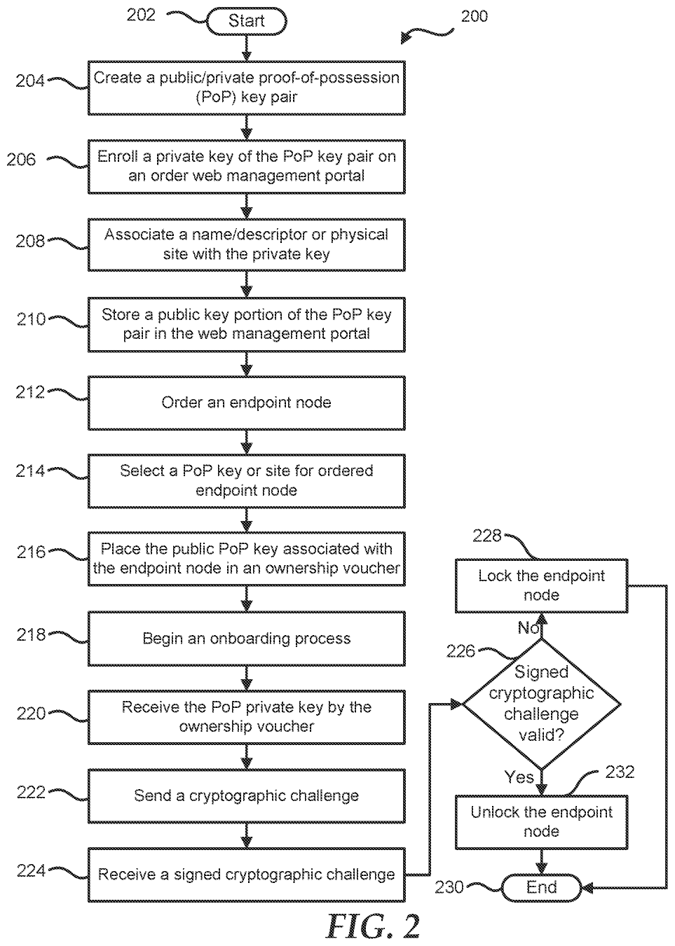

FIG. 2 illustrates a flow of a method 200 for unlocking an endpoint node in an anointed network according to at least one embodiment of the present disclosure, starting at block 202. The operations described with respect to FIG. 2 may be performed by any suitable component including, but not limited to, user node 102 of FIG. 1, endpoint node 104 of FIG. 1, control plane node 108 of FIG. 1, and information handling system 500 of FIG. 5. It will be readily appreciated that not every method step set forth in this flow diagram is always necessary, and that certain steps of the methods may be combined, performed simultaneously, in a different order, or perhaps omitted, without varying from the scope of the disclosure.

At block 204, a public/private POP key pair is created. In certain example, the public/private POP key pair may be created in a control plane node, in a user node, or the like. If the POP key pair is created in a component other than the control plane node, the public/private PoP key pair is provided to the control plane node. At block 206, a private key of the POP key pair is enrolled on an order management web portal. At block 208, a name/descriptor or physical site is associated with the POP private key.

At block 210, the public key portion of the POP key pair is stored in the web management portal. In an example, the public key may be subsequently used via the web management portal. At block 212, an endpoint node is ordered. In certain examples, the endpoint node may be ordered through any suitable graphical user interface such as an ordering portal. During the ordering processor of the endpoint, a POP key or site is selected to be associated with the ordered endpoint node at block 214.

At block 216, the public POP key associated with the endpoint node is placed in an OV. In an example, the POP key may be stored in the OV during a voucher transfer process. At block 218, an onboarding process is begun in the endpoint node. At block 220, the POP private key is received by the OV. At block 222, a cryptographic challenge is sent to the control plane node. At block 224, a signed cryptographic challenge is received from the control plane node. In an example, the signed cryptographic challenge may be signed with the POP private key.

At block 226, a determination is made whether the signed cryptographic challenge is valid. In an example, the signed cryptographic challenge is valid if the signature is verified by the public POP key on boarded to the endpoint node. If the signed cryptographic challenge is not validated, the endpoint node remains locked at block 228 and the method ends at block 230. If the signed cryptographic challenge is validated, the endpoint node is unlocked and may be access by a user node at block 232 and the flow ends at block 230.

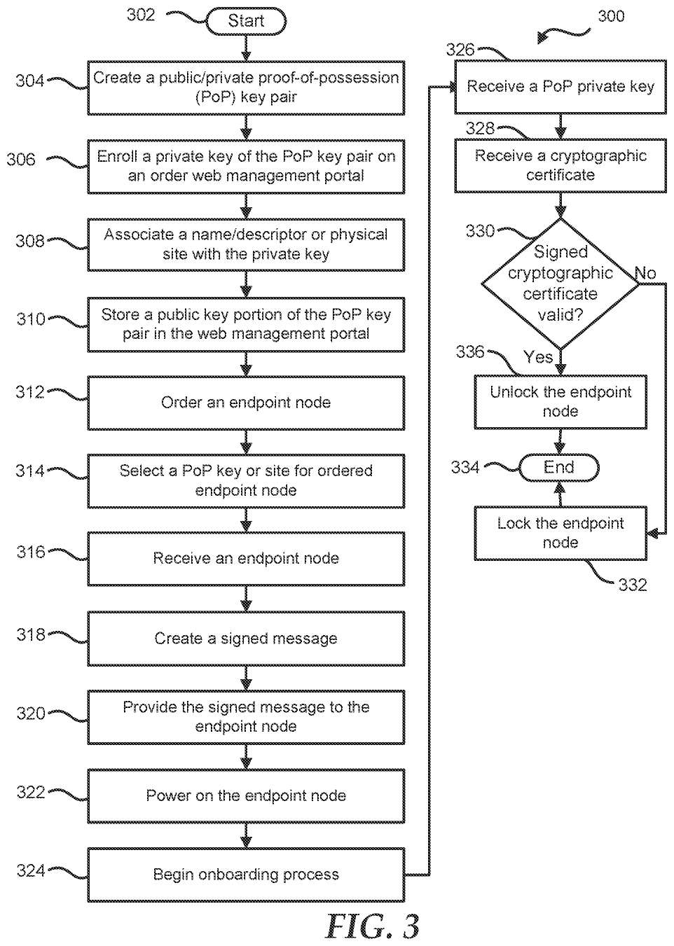

Referring back to FIG. 1, POP private key 170 may be saved in storage 122 of user node 102. In an example, user node 102 may utilize PoP private key 170 to asynchronously sign a message and the message may authorize endpoint node 104. In certain examples, the signed message may alternatively come from outside user node 102, such as from authenticator 106 or control plane node 108. In an example, authenticator 106 may be a roaming authenticator, such as a universal serial bus (USB) key, a SD card, a cellular telephone, or the like. In this situation, the signed message may be received as a signed certificate that is signed by POP private key 170. The operations to provide an asynchronously signed message to activate or unlock endpoint node 104 will be described with respect to FIG. 3 below.

FIG. 3 illustrates a flow of a method 300 for providing an asynchronously signed message to activate or unlock endpoint node according to at least one embodiment of the present disclosure, starting at block 302. The operations described with respect to FIG. 3 may be performed by any suitable component including, but not limited to, user node 102 of FIG. 1, endpoint node 104 of FIG. 1, control plane node 108 of FIG. 1, and information handling system 500 of FIG. 5. It will be readily appreciated that not every method step set forth in this flow diagram is always necessary, and that certain steps of the methods may be combined, performed simultaneously, in a different order, or perhaps omitted, without varying from the scope of the disclosure.

At block 304, a public/private POP key pair is created. In certain example, the public/private PoP key pair may be created in a control plane node, in a user node, or the like. If the POP key pair is created in a component other than the control plane node, the public/private PoP key pair is provided to the control plane node. At block 306, a private key of the POP key pair is enrolled on an order management web portal. At block 308, a name/descriptor or physical site is associated with the POP private key.

At block 310, the public key portion of the POP key pair is stored in the web management portal. In an example, the public key may be subsequently used via the web management portal. At block 312, an endpoint node is ordered. In certain examples, the endpoint node may be ordered through any suitable graphical user interface such as an ordering portal. During the ordering processor of the endpoint, a PoP key or site is selected to be associated with the ordered endpoint node at block 314.

At block 316, the endpoint node is selected as received. In an example, the selection may be made by a user via a web management portal. At block 318, a signed message is created. In certain examples, the signed message is signed with the private POP key and may indicate that the endpoint node is in safe possession. At block 320, the signed message is provided to the endpoint node. In an example, the signed message may be provided in any suitable manner including, but not limited to, storing the signed message in a roaming authenticator and manually plugging the roaming authenticator into the endpoint node, and providing the signed message from a user node, such as user node 102 of FIG. 1, through a control plane, such as control plane node 108 of FIG. 1, to the endpoint node. In certain examples, the roaming authenticator may be substantially equal to authenticator 106, such as a USB key, a SD card, or the like.

At block 322, the endpoint node is powered on. In response to the endpoint node being powered on, an onboarding process is begun in the endpoint node at block 324. During the onboarding process, the POP private key is received by the OV for the endpoint node at block 326. At block 328, a cryptographic certificate is received by the endpoint node. In an example, the cryptographic certificate may be signed by the POP private key. The cryptographic message may be received in any suitable manner including, but not limited to, from a roaming authenticator being manually plugging into the endpoint node, and from a user node, such as user node 102 of FIG. 1, through a control plane, such as control plane node 108 of FIG. 1. In certain examples, the roaming authenticator may be substantially equal to authenticator 106, such as a USB key, a SD card, or the like.

At block 330, a determination is made whether the signed certificate is valid. In an example, the signed certificate is valid if the signature is verified by the public POP key on boarded to the endpoint node. If the signed certificate is not validated, the endpoint node remains locked at block 332 and the method ends at block 334. If the signed certificate is validated, the endpoint node is unlocked and may be accessed by a user node at block 336 and the flow ends at block 334.

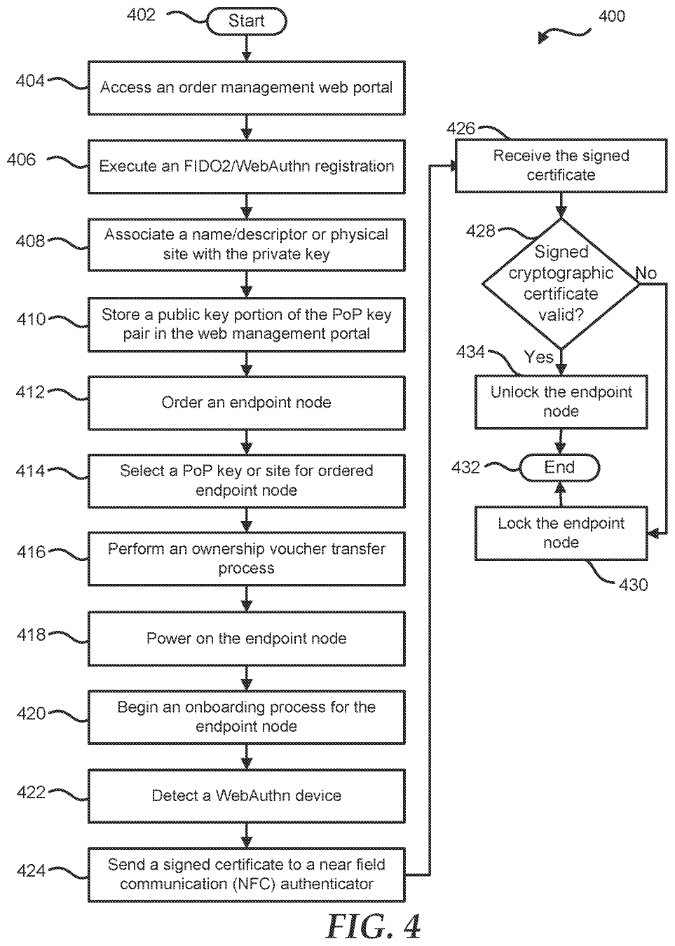

Referring back to FIG. 1, roaming authenticator 106 may be any suitable device including, but not limited to, a smart card device, a FIDO2/WebAuthn key, an NFC device, a Bluetooth device. In an example, roaming authenticator 106 may securely hold POP private key 170. In this example, POP private key 170 may be exported, either to control plane node 108, an ordering management portal, or the like during an enrollment process. During the enrollment process, a user of user node 102 may specify public key 162 to be an authority key for POP purposes, for endpoint node 104 as determine at ordering time of endpoint node 104. In certain examples, if private key 170 is enrolled, use of this key and an associated physical authenticator, such as roaming authenticator 106, may be used to prove that endpoint node 104 is in safe-possession. In an example, the operations to provide a local PKI challenge to activate or unlock endpoint node 104 will be described with respect to FIG. 4 below.

FIG. 4 illustrates a flow of a method 400 for providing and authenticating a local PKI challenge to activate or unlock endpoint node according to at least one embodiment of the present disclosure, starting at block 402. The operations described with respect to FIG. 3 may be performed by any suitable component including, but not limited to, user node 102 of FIG. 1, endpoint node 104 of FIG. 1, control plane node 108 of FIG. 1, and information handling system 500 of FIG. 5. It will be readily appreciated that not every method step set forth in this flow diagram is always necessary, and that certain steps of the methods may be combined, performed simultaneously, in a different order, or perhaps omitted, without varying from the scope of the disclosure.

At block 404, a user may access an order management web portal. In an example, the user may utilize a user node, such as user node 102 to access the order management web portal. At block 406, an FIDO2/WebAuthn registration may be executed to extract and validate a private key from an authenticator, such as authenticator 106 of FIG. 1. In an example, the WebAuthn registration may be utilized to create a public/private POP key pair is created. In certain example, the public/private POP key pair may be created in a control plane node, in a user node, or the like. In certain examples, the roaming authenticator may be substantially equal to authenticator 106, such as a USB key, a SD card, a cellular telephone, a near filed communication (NFC) key/card, or the like. At block 408, a name/descriptor or physical site is associated with the POP private key.

At block 412, an endpoint node is ordered. In certain examples, the endpoint node may be ordered through any suitable graphical user interface such as an ordering portal. During the ordering processor of the endpoint, a POP key or site is selected to be associated with the ordered endpoint node at block 414. At block 416, an OV transfer process is performed. In an example, during the OV transfer process, the POP key is placed in the OV.

At block 418, the endpoint node is powered on. In response to the endpoint node being powered on, an onboarding process is begun in the endpoint node at block 420. During the onboarding process, the POP key is received by the OV of the endpoint node. At block 422, the WebAuthn authenticator is detected by the endpoint node. In an example, the WebAuthn authenticator may be detected by any suitable manner, such as via an NFC. At block 424, a cryptographic challenge is sent to the NFC authenticator. At block 426, a signed cryptographic challenge is received from the NFC authenticator. In an example, the signed cryptographic challenge may be signed with the POP private key stored within the NFC authenticator.

At block 428, a determination is made whether the signed cryptographic challenge is valid. In an example, the signed cryptographic challenge is valid if the signature is verified by the public PoP key on boarded to the endpoint node. If the signed cryptographic challenge is not validated, the endpoint node remains locked at block 430 and the method ends at block 432. If the signed cryptographic challenge is validated, the endpoint node is unlocked and may be access by a user node at block 434 and the flow ends at block 432.

As described herein, user node 102 may be utilized to assign PoP keys to control plane 108, which may be local or on-site with respect to endpoint node 104. In an example, different PoP keys may be assigned to different endpoint nodes by binding the POP keys to different previously established locations, such as control plane 108. In certain examples, multiple control plane nodes, or other entities, may be assigned site-specific POP keys. A user may utilize any suitable component to manually specify that endpoint node 104 has been received in safe possession.

In an example, a user may utilize control plane node 108 or any other network service to manually specify that endpoint node 104 is in safe possession. Additionally, a user may manually specify that endpoint node 104 is in safe possession via a local physical process. In certain examples, a user may specify safe possession of endpoint node 106 via a pre-signed (PKI) certificate, a cryptographic challenge, or the like. In an example, the safe-possession cryptographic challenge may be provided via a physical PKI key or smart-card to sign a challenge from a local device, such as a USB key fob. User node 102 may enable a user to enroll a PoP public key into a portal of control plane node 108, an ordering portal, or the like. In an example, a FIOD2/WebAuthn roaming authenticator key stored within roaming authenticator 106 may be provided as PoP. An NFC component or device may be utilized to receive a PKI challenge and provide the NFC PKI response to provide proof of safe possession.

FIG. 5 shows a generalized embodiment of an information handling system 500 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 562, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 530 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 5394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An endpoint node of a multiple node environment, the endpoint node comprising:
a storage configured to store a public key of a public/private key pair, and an ownership voucher; and
a processor to communicate with the storage, the processor to:
begin an onboarding process;
receive a signed message, wherein the signed message indicates safe possession of the endpoint node;
retrieve the public key from the ownership voucher in a storage of the endpoint node;
based on the public key, determine whether the signed message is valid; and
in response to the signed message being valid, unlock the endpoint node.

2. The endpoint node of claim 1, wherein the processor further to:
enroll the public/private key pair on an order management portal;
storing the private key in a roaming authenticator device; and
storing the public key as a proof-of possession key in an ownership voucher for the endpoint node.

3. The endpoint node of claim 1, wherein the processor further to:
provide a cryptographic challenge; and
receive a signed version of the cryptographic challenge, wherein the signed version of the cryptographic challenge is signed with a private key of the public/private key pair, wherein the signed version of the cryptographic challenge is the signed message.

4. The endpoint node of claim 1, wherein in response to the signed message not being valid, the processor further to: lock the endpoint node.

5. The endpoint node of claim 1, wherein the signed message is received from a roaming authenticator.

6. The endpoint node of claim 1, wherein the signed message is received via a near field communication.

7. The endpoint node of claim 1, wherein the on boarding process is a portion of a secure zero touch provisioning process in the endpoint node.

8. The endpoint node of claim 1, wherein the on boarding process is performed during a first power on of the endpoint node.

9. A method comprising:
beginning, at an endpoint node in a multiple node environment, an onboarding process;
receiving, by a processor of the endpoint node, a signed message, wherein the signed message indicates safe possession of the endpoint node;
retrieving, by the processor, a public key from an ownership voucher in a storage of the endpoint node;
determining, by the processor, whether the signed message is valid based on the public key; and
in response to the signed message being valid, unlocking the endpoint node.

10. The method of claim 9, further comprising:
enrolling, a public/private key pair on an order management portal, wherein the key pair includes a private key and the public key;
storing the private key in a roaming authenticator device; and
storing the public key as a proof-of possession key in an ownership voucher for the endpoint node.

11. The method of claim 9, further comprising:
providing a cryptographic challenge; and
receiving a signed version of the cryptographic challenge, wherein the signed version of the cryptographic challenge is signed with a private key of the public/private key pair, wherein the signed version of the cryptographic challenge is a signed message.

12. The method of claim 9, further comprising: in response to the signed message not being valid, locking the endpoint node.

13. The method of claim 9, wherein the signed message is received from a roaming authenticator.

14. The method of claim 9, wherein the signed message is received via a near field communication.

15. The method of claim 9, wherein the on boarding process is a portion of a secure zero touch provisioning process in the endpoint node.

16. The method of claim 9, wherein the on boarding process is performed during a first power on of the endpoint node.

17. A method comprising:
enrolling a public/private key pair on an order management portal, wherein the key pair includes a private key and a public key;
storing the private key in a roaming authenticator device;
storing the public key as a proof-of possession key in an ownership voucher for the endpoint node;
beginning, at an endpoint node in a multiple node environment, an onboarding process;
providing a cryptographic challenge;
receiving a signed cryptographic challenge, wherein the signed cryptographic challenge is signed with a private key of the public/private key pair;
receiving, by the endpoint node, a signed message, wherein the signed cryptographic challenge indicates safe possession of the endpoint node;
retrieving a public key of the public/private key pair from the ownership voucher in a storage of the endpoint node; and
if the signed cryptographic challenge is valid based on the public key, then unlocking the endpoint node.

18. The method of claim 17, wherein the signed cryptographic challenge is received via a control panel node.

19. The method of claim 17, wherein the signed cryptographic challenge is received from a roaming authenticator.

20. The method of claim 17, wherein the onboarding process is a portion of a secure zero touch provisioning process in the endpoint node.
